(19) United States
(12) Patent Application Publication
(10) Pub. No.: US 2013/0162198 A1
(43) Pub. Date: Jun. 27, 2013

(54) INFORMATION PROCESSING APPARATUS AND CONTROL METHOD

(71) Applicant: Kabushiki Kaisha Toshiba, Tokyo (JP)

(72) Inventors: Ryuhei YOKOTA, Tachikawa-shi (JP); Katsuhiro UCHIDA, Ome-shi (JP)

(73) Assignee: KABUSHIKI KAISHA TOSHIBA, Tokyo (JP)

(21) Appl. No.: 13/724,983

(22) Filed: Dec. 21, 2012

(30) Foreign Application Priority Data
Dec. 27, 2011 (JP) 2011-285836

(51) Int. Cl. H02J 7/00

(52) U.S. Cl. CPC H02J 7/007
USPC 320/107; 320/162

(57) ABSTRACT

According to one embodiment, an information processing apparatus, which is capable of charging batteries of a plurality of portable devices, includes ports, a current detector and a power supply controller. The plurality of portable devices are detachably attached to the ports. The current detector detects a current drawn to each of the plurality of portable devices when the plurality of portable devices are attached to the ports. The power supply controller prevents a current of a first threshold or more from being drawn to a first portable device other than a predetermined number of portable devices among the plurality of portable devices, when the current drawn to each of the predetermined number of portable devices is the first threshold or more.

### CROSS-REFERENCE TO RELATED APPLICATIONS

This application is based upon and claims the benefit of priority from prior Japanese Patent Application No. 2011-285836, filed Dec. 27, 2011, the entire contents of which are incorporated herein by reference.

### FIELD

Embodiments described herein relate generally to an information processing apparatus having a charger function that is capable of charging a battery of a portable device, and a control method which is applied to the information processing apparatus.

### BACKGROUND

In recent years, various portable devices having functions, which support the universal serial bus (USB) 2.0 standard, have been used. The portable device is detachably attached to a USB port of a host device such as a personal computer. The portable device can receive power, which is called “bus power”, from the host device. Before a connection is established between the portable device and the host device, the amount of current (amperage), which can be drawn into the portable device from the host device, is limited to a predetermined amount.

In addition, recently, use has been made of a host device having a charger function that is capable of charging a battery of the portable device. The host device having the charger function can supply to the portable device a current which is greater than a current that is defined in the USB 2.0 specification.

In recent years, the number of portable devices having large-capacity batteries has been increasing. Some of such large-capacity batteries have functions (quick charging) that can execute high-speed charging by power supply with a large current.

However, the capacity of power, which can be supplied by the host device to the portable device, is limited. For example, when power is supplied to a plurality of portable devices at the same time, it is possible that a current, which is greater than the current that can be supplied by the host device, is drawn into the plural portable devices. In such a case, there is concern that the host device becomes unstable or the convenience for a user deteriorates.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an example of the external appearance of an information processing apparatus according to an embodiment.

FIG. 2 is an exemplary block diagram showing an example of the system configuration of the information processing apparatus of the embodiment.

FIG. 3 is an exemplary view for explaining examples of the status of a USB port which is used in the information processing apparatus of the embodiment.

FIG. 4 is an exemplary block diagram for describing an example of a power supply control circuit which controls power supply to a portable device that is attached to the USB port.

FIG. 5 is an exemplary block diagram for describing an example of a power supply control circuit which controls power supply to two portable devices that are attached to two USB ports.

FIG. 6 is an exemplary flowchart illustrating an example of the procedure of a power supply control process which is executed by the power supply control circuit shown in FIG. 4 or FIG. 5.

FIG. 7 is an exemplary block diagram for describing an example of a power supply control circuit which is provided in the information processing apparatus of the embodiment.

FIG. 8 is an exemplary block diagram for describing another example of the power supply control circuit which is provided in the information processing apparatus of the embodiment.

FIG. 9 is an exemplary view for explaining examples of signals which are used in the power supply control circuit shown in FIG. 8.

FIG. 10 is an exemplary block diagram for describing still another example of the power supply control circuit which is provided in the information processing apparatus of the embodiment.

FIG. 11 is an exemplary flowchart illustrating an example of the procedure of a power supply control process which is executed by the information processing apparatus of the embodiment.

FIG. 12 is an exemplary flowchart illustrating an example of the procedure of a quick charging control process which is executed by the information processing apparatus of the embodiment.

FIG. 13 is an exemplary flowchart illustrating another example of the procedure of the quick charging control process which is executed by the information processing apparatus of the embodiment.

### DETAILED DESCRIPTION

Various embodiments will be described hereinafter with reference to the accompanying drawings.

In general, according to one embodiment, an information processing apparatus, which is configured to be capable of charging batteries of a plurality of portable devices, includes a plurality of ports, a current detector and a power supply controller. The plurality of portable devices are detachably attached to the plurality of ports. The current detector is configured to detect a current drawn to each of the plurality of portable devices when the plurality of portable devices are attached to the plurality of ports. The power supply controller is configured to prevent a current of a first threshold or more from being drawn to a first portable device other than a predetermined number of portable devices among the plurality of portable devices, when the current drawn to each of the predetermined number of portable devices is equal to or greater than the first threshold.

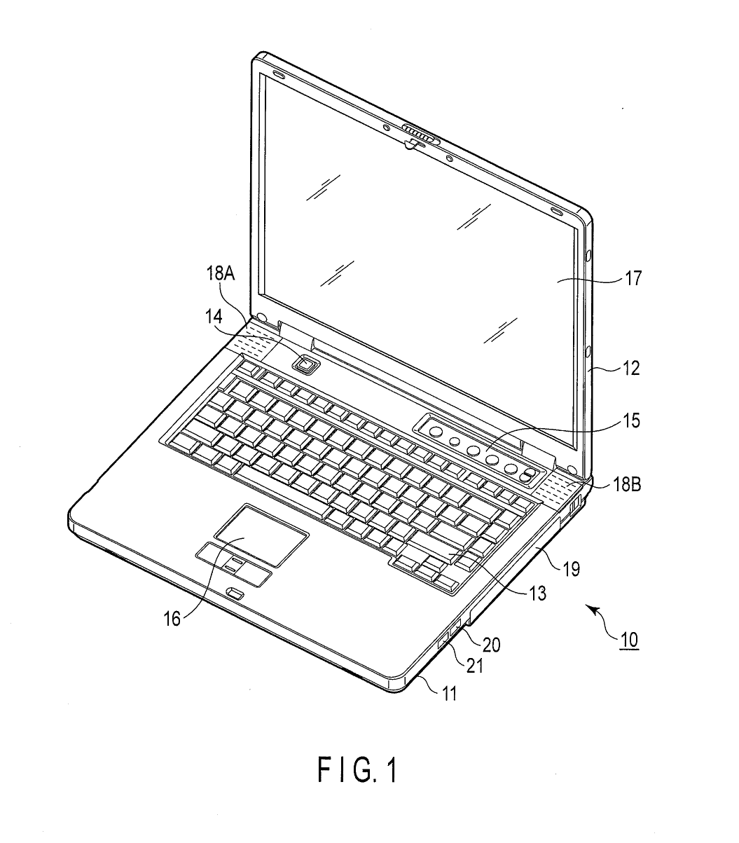

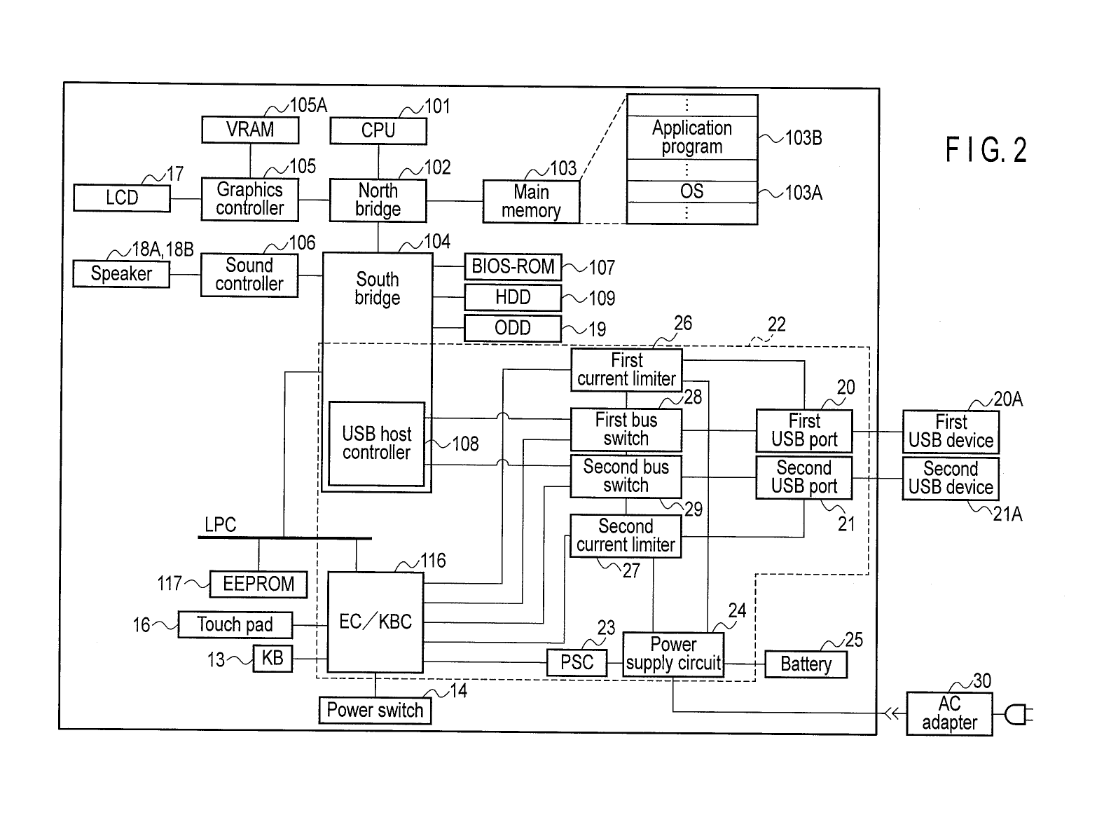

To begin with, referring to FIGS. 1 and 2, the structure of an information processing apparatus according to an embodiment is described. This information processing apparatus is realized, for example, as a notebook-type personal computer (PC) 10. In addition, this information processing apparatus may be realized, for example, as a tablet-type PC, a desktop-type PC, or an embedded system which is incorporated in various kinds of electric devices.

FIG. 1 is a perspective view of the computer 10. The computer 10 includes a computer main body 11 and a display unit 12. A display device, which is composed of a liquid crystal display (LCD) 17, is built in the display unit 12.

The display unit 12 is attached to the computer main body 11 such that the display unit 12 is rotatable between an open position where the top surface of the computer main body 11 is exposed, and a closed position where the top surface of the computer main body 11 is covered. The computer main body 11 has a thin box-shaped housing. A keyboard 13, a power button 14 for powering on/off the computer 10, an input operation panel 15, a touch pad 16, and speakers 18A and 18B are disposed on the top surface of the housing of the computer main body 11. An optical disc drive (ODD) 19, a first USB port 20 and a second USB port 21 are provided, for example, on a right side surface of the computer main body 11. The input operation panel 15 is an input device for inputting an event corresponding to a pressed button, and includes a plurality of buttons for activating a plurality of functions.

Next, referring to FIG. 2, the system configuration of the computer 10 is described.

The computer 10, as shown in FIG. 2, includes a CPU 101, a north bridge 102, a main memory 103, a south bridge 104, a graphics controller 105, a video memory (VRAM) 105A, a sound controller 106, a BIOS-ROM 107, a hard disk drive (HDD) 109, an ODD 19, a first USB port 20, a second USB port 21, a first current limiter 26, a second current limiter 27, a first bus switch 28, a second bus switch 29, an embedded controller/keyboard controller (EC/KBC) 116, an EEPROM 117, a keyboard (KB) 13, a power switch 14, a touch pad 16, a power supply controller (PSC) 23, a power supply circuit 24, a battery 25, and an AC adapter 30.

The CPU 101 is a processor for controlling the operations of the respective components in the computer 10. The CPU 101 executes an operating system (OS) 103A and various application programs 103B, which are loaded from the HDD 109 into the main memory 103. In addition, the CPU 101 executes a basic input/output system (BIOS) that is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the graphics controller 105 via, e.g. a PCI EXPRESS serial bus.

The graphics controller 105 is a display controller which controls the LCD 17 used as a display monitor of the computer 10. A display signal, which is generated by the graphics controller 105, is sent to the LCD 17.

The south bridge 104 controls devices on a Low Pin Count (LPC) bus. The south bridge 104 includes an Integrated Drive Electronics (IDE) controller for controlling the HDD 109 and ODD 19.

The south bridge 104 also has a function of communicating with the sound controller 106. The sound controller 106 is a sound source device. The sound controller 106 outputs audio data, which is to a target of playback, to the speakers 18A and 18B.

Besides, the south bridge 104 includes a USB host controller (hereinafter also referred to as “host controller”) 108 for controlling portable devices (hereinafter also referred to as “USB devices”) 20A and 21A which are detachably attached to the USB ports 20 and 21. In the meantime, the USB host controller 108 may be provided outside the south bridge 104. The portable device 20A, 21A is, for instance, a portable music player, a tablet-type computer, or a smartphone.

The EC/KBC 116 is a one-chip microcomputer in which an embedded controller for power management and a keyboard controller for controlling the keyboard 13 and touch pad 16 are integrated.

The embedded controller has a function of powering on/off the computer 10 in accordance with the user's operation of the power button 14, in cooperation with the PSC 23 and power supply circuit 24. The power supply circuit 24 supplies power to the respective components in the computer 10, by using power supplied from outside via the AC adapter 30 or power supplied from the battery 25. In other words, the computer 10 is driven by power supplied from an external power supply such as an AC commercial power supply or by power supplied from the battery 25. The AC adapter 30 may be provided within the computer 10.

When the embedded controller receives a signal, which indicates over-current, from the current limiter (current limit IC) 26, 27, the embedded controller outputs a signal, which instructs an interrupt of power supply to the USB port 20, 21, to the current limiter 26, 27.

In response to an instruction from the embedded controller, the power supply controller (PSC) 23 controls the supply/stop of power by the power supply circuit 24. Under the control of the power supply controller (PSC) 23, the power supply circuit 24 generates voltages which are to be supplied to the respective components in the computer 10, and supplies, for example, a predetermined voltage (e.g. 5 V) to the current limiter 26, 27.

The current limiters 26 and 27 supply, via power lines, power (voltage: e.g. 5 V) to portable devices which are attached to two USB interfaces (USB ports 20 and 21).

In addition, the USB host controller 108, EC/KBC 116, current limiters 26 and 27, bus switches (bus SW IC) 28 and 29, USB ports 20 and 21, PSC 23 and power supply circuit 24 constitute a power supply control circuit 22 which controls currents drawn to the USB devices 20A and 21A. For example, in accordance with a status (also referred to as “charging mode”) which is set by a user, the power supply control circuit 22 supplies power with an amount of current specified for this status to the USB device 20A, 21A.

In recent years, as the USB device 20A, 21A that is attached to the USB port 20, 21, there has been proposed a device which includes a large-capacity battery and has a function which enables quick charging of the large-capacity battery. The computer 10 has a function for executing quick charging (e.g. power supply up to 5 V and 2 A) of the USB device 20A, 21A. In the power supply control circuit 22, for example, the charging with a current of a first threshold (e.g. 1.5 A) or more is regarded as quick charging, and the number of USB ports, for which such quick charging is executed, is limited, thereby executing such control that the total power supplied to the USB devices 20A and 21A does not exceed the power capacity that can be supplied by the computer 10. The operation in the power supply control circuit 22 will be described below.

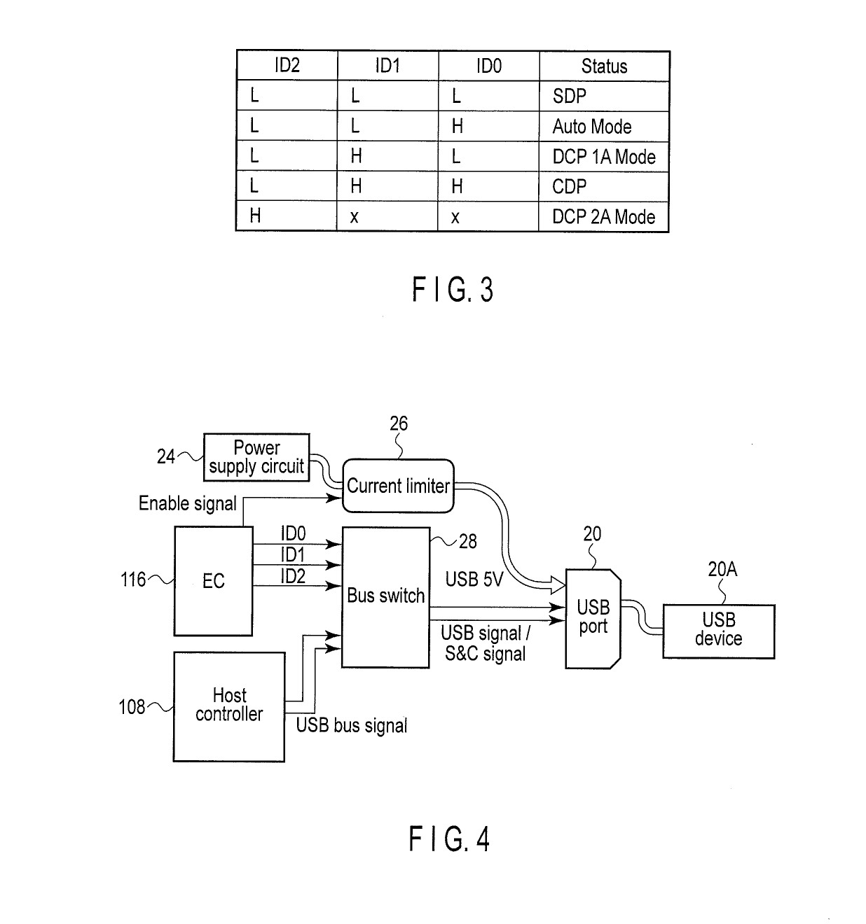

FIG. 3 shows examples of the statuses (charging modes) of the USB ports and status signals ID0, ID1 and ID2 (hereinafter also expressed as ID [2:0]) for notifying the status. The statuses include, for example, a standard downstream port (SDP), an auto mode, a dedicated charging port (DCP) 1A mode, a charging downstream port (CDP), and a dedicated charging port (DCP) 2A mode. In each status, the maximum current, which is used for power supply, is defined.

The SDP is a downstream port on a USB compliant device. In the SDP, power supply to the portable device is executed with a current up to 0.5 A in the case of USB 2.0 and with a current up to 0.9 A in the case of USB 3.0. When the portable device has been attached to the port set as the SDP, enumeration is executed between the portable device and the host. The enumeration is first data exchange which is performed between the device and the host in order to specify the device type. Since the SDP is so-called pass-through, communication with the portable device is executed by a USB signal which is output by the host controller 108.

The auto mode is a state in which either a special mode or the DCP 1A mode is set. The special mode is specialized for charging a specified portable device (e.g. a device provided by a specified vendor, or a specified product). In the auto mode, for example, the special mode is selected when the attached portable device is the specified portable device, and the DCP 1A mode is selected when the portable device is not the specified portable device. In the special mode, for example, power is supplied to the portable device with a predetermined current.

The special mode, DCP 1A mode and DCP 2A mode are states in which charging is executed without communication (digital communication) with the portable device. Specifically, in the special mode, DCP 1A mode and DCP 2A mode, charging can be started without the above-described enumeration. In the DCP 1A mode, power is supplied to the portable device with a current up to 1A. In the DCP 2A mode, power is supplied to the portable device with a current up to 2 A. In the DCP 2A mode, such quick charging can be executed that the maximum current drawn to the portable device is equal to or greater than a first threshold. The DCP 2A mode is also called “first status”. In the DCP 1A mode or in the auto mode, the maximum current drawn to the portable device is less than the first threshold, and these modes are also called “second status”.

The CDP is a state in which a higher current can be supplied than in the SDP. In the CDP, for example, power is supplied to the portable device with a current up to 1.5 A. The portable device starts quick charging when the portable device confirms that the system side supports the CDP, prior to the execution of enumeration.

In addition, the SDP and CDP are statuses which are used when the system state is S0 (working state). The auto mode, DCP A1 mode and DCP 2A mode are statuses which are used for charging at a time of a power-saving state (“sleep & charge”) when the system state is S3 (standby), S4 (hibernation) or S5 (power-off). The user selects the status in accordance with a portable device which is to be charged. The EC/KBC 116 sets the status for each USB port in accordance with the selection by the user. For example, at the time of the power-saving state, the EC/KBC 116 sets one of the DCP 2A mode (first status), auto mode and DCP 1A mode (second status) for each USB port.

As indicated by the status ID [2:0] in FIG. 3, the status is uniquely identified by a combination of signal “L” (Low) and signal “H” (High). In the meantime, in the DCP 2A mode, a signal indicated by “x” may be either signal “L” or signal “H”.

Referring to FIG. 4, a description is given of the power supply control circuit for supplying power to the USB device 20A attached to a USB port 20.

To begin with, in accordance with the status set by the user, for example, the EC 116 notifies the bus switch 28 of the status ID [2:0] that is a signal corresponding to the set status. This notification is executed, for example, at a timing when the system state has transitioned from S0 to Sx (i.e. a power-saving state of S3, S4 or S5). When the system state is the power-saving state, the status is set to be one of the auto mode, DCP 1A mode and DCP 2A mode.

The bus switch 28 is a switch IC which switches the bus in accordance with notification by the EC 116. Specifically, in accordance with the status ID [2:0], the bus switch 28 switches the path for passing a USB bus signal, which is output by the host controller 108, through to the USB port 20, the unique value used in the bus switch 28, and the path connected to the USB port 20. Thereby, communication is controlled according to the status between the host controller 108 and the USB device 20A that is attached to the USB port 20. In addition, power is supplied to the USB port 20 with a current up to the maximum current specified for the status (or a predetermined current specified for the status). When it is detected that the USB device 20A is attached to the USB port 20 and the detected USB device 20A supports the set status, the charging of the USB device 20A is started with power that is supplied to the USB port 20 via the power supply circuit 24, etc.

The current limiter 26 is an IC that is inserted in a power supply line, through which power is supplied from the power supply circuit 24 to the USB port 20, and that stops an output when the supplied current has exceeded a predetermined current. The power that is supplied from the power supply circuit 24 to the USB port 20 has a predetermined voltage (e.g. 5 V). The current limiter 26 starts the power supply to the USB port 20, in response to an enable signal output by the EC 116. Then, the current limiter 26 monitors the current supplied to the USB port 20 (i.e. the current drawn to the USB device 20A), and stops (interrupts) the current drawn to the USB device 20A when the current has exceeded a second threshold (e.g. 2 A). To be more specific, when the current has exceeded the second threshold, the current limiter 26 notifies the EC 116 that the current has exceeded the second threshold (over-current). Responding to the notification by the current limiter 26, the EC 116 outputs the disable signal to the current limiter 26. Then, responding to the disable signal output by the EC 116, the current limiter 26 stops the power supply to the USB port 20 (i.e. shuts off the current to the USB port 20).

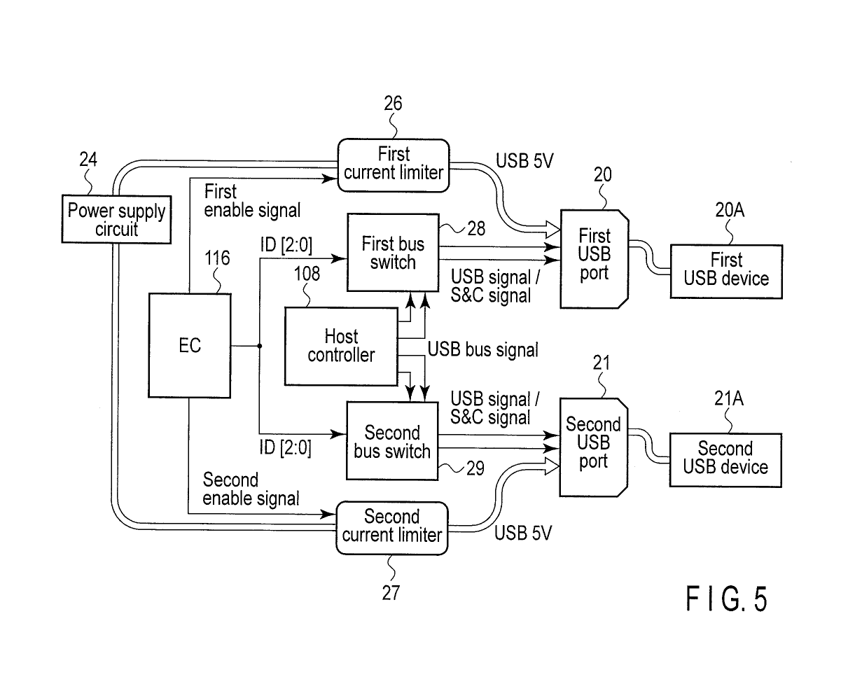

Next, referring to FIG. 5, a description is given of a power supply control circuit for supplying power to USB devices 20A and 21A which are attached to plural USB ports 20 and 21. When two USB ports 20 and 21 are provided, the EC 116 notifies the first bus switch 28 and second bus switch 29 of the status ID [2:0] that is a signal corresponding to the status, for example, in accordance with the status set by the user. That is, the same status is set for the two USB ports 20 and 21. In the meantime, if there is an allowance in pin assignment of the EC 116, signals indicative of different statuses (i.e. different status IDs [2:0]) may be notified to the first bus switch 28 and second bus switch 29. Thereby, the USB ports 20 and 21 can be controlled by different statuses. The other structural parts in the power supply control circuit operate in the same manner as in the structure described with reference to FIG. 4.

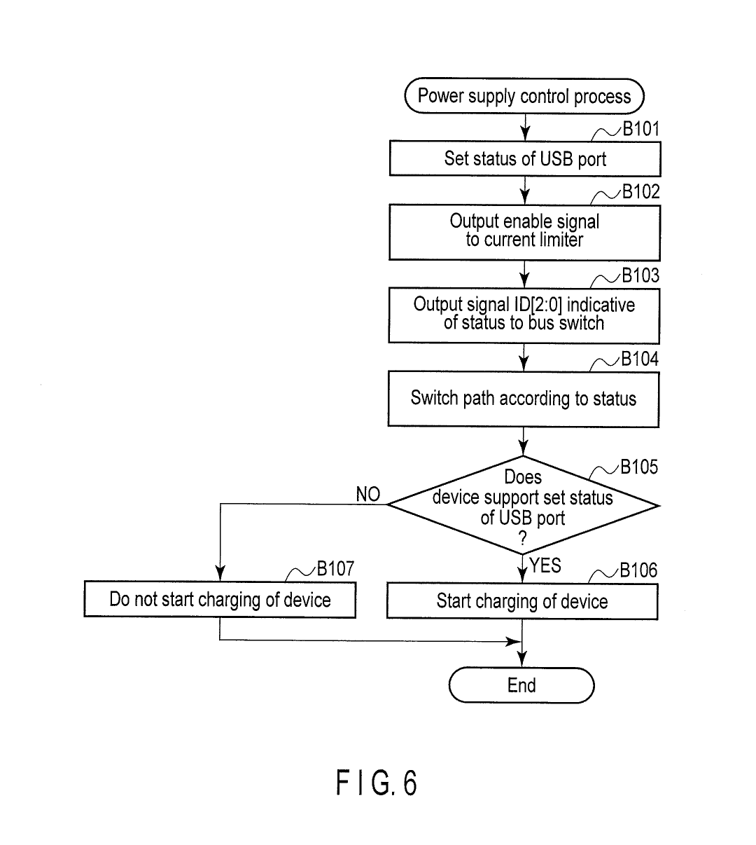

Next, referring to a flowchart of FIG. 6, a description is given of an example of the procedure of a power supply control process which is executed by the power supply control circuit shown in FIG. 4 or FIG. 5.

To start with, the EC 116 sets the status of the USB port 20, 21 (block B101). For example, according to the setting by the user, the EC 116 sets the status of the USB port 20, 21. Next, the EC 116 outputs an enable signal to the current limiter 26, 27 (block B102). Responding to the enable signal which has been output by the EC 116, the current limiter 26, 27 supplies power to the USB port 20, 21. In addition, the EC 116 outputs to the bus switch 28, 29 a status ID [2:0] that is a signal indicative of the set status (block B103). In accordance with the status, the bus switch 28, 29 switches the path for passing a USB bus signal through to the USB port 20, 21, and the path that connects the bus switch 28, 29 and the USB port 20, 21 (block B104).

Next, the USB device 20A, 21A, which is attached to the USB port 20, 21, determines whether the device supports the status set in the USB port 20A, 21A (block B105). If the USB device 20A, 21A supports the status of the USB port 20, 21 (YES in block B105), the charging of the USB device 20A, 21A is started via the USB port 20, 21 (block B106). On the other hand, if the USB device 20A, 21A does not support the status of the USB port 20, 21 (NO in block B105), the charging of the USB device 20A, 21A is not started (block B107).

By the above procedure, the charging of the USB device 20A, 21A, which is attached to the USB port 20, 21, is controlled based on the status set for the USB port 20, 21. However, when the charging of the USB device 20A, 21A is executed based on only the status of the USB port 20, 21, it is possible that the total power supplied to the USB device 20A, 21A exceeds the power that can be supplied by the computer 10. For example, when the computer 10 can supply a current up to 2 A with a voltage of 5 V to external USB devices, if power of a voltage 5 V and a current of 1.5 A is supplied in the DCP 2A mode to the first USB device 20A, and power of a voltage 5 V and a current of 1.5 A is supplied in the DCP 2A mode to the second USB device 21A, the total power that is supplied to the USB devices 20A and 21A exceeds the power that can be supplied by the computer 10. Consequently, it is possible that the operation of the computer 10 becomes unstable or the convenience for the user deteriorates.

Taking this into account, in the present embodiment, the number of USB ports, to which a current of a first threshold (e.g. 1.5 A) or more is supplied, is limited so that the total power which is supplied to the USB devices 20A and 21A may not exceed the power that can be supplied by the computer 10. The number of USB ports, to which the current of the first threshold or more is supplied, is limited to, for example, one.

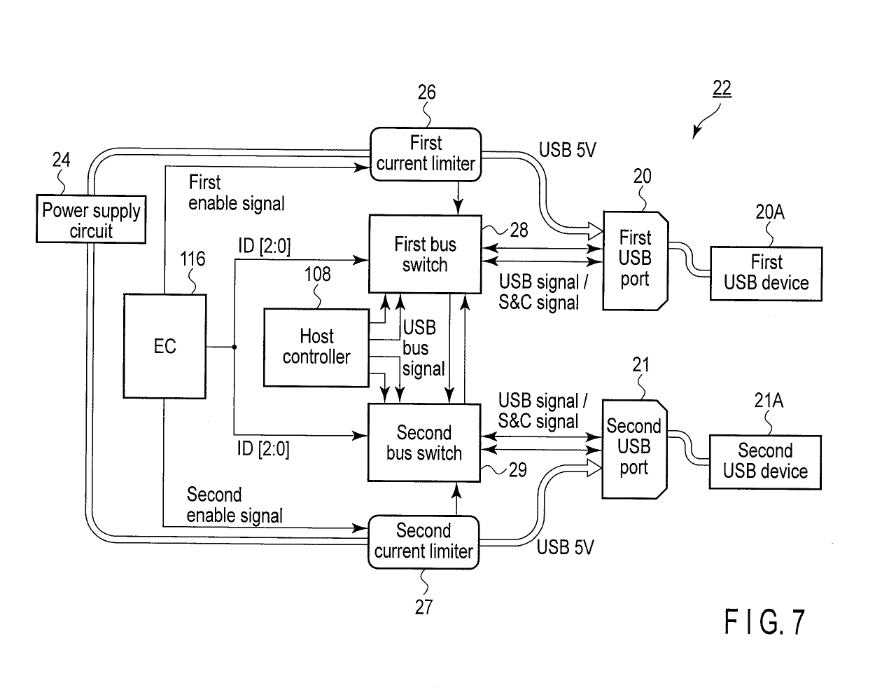

Referring to FIG. 7, a description is given of the operation of the power supply control circuit 22 which is provided in the computer 10 of the embodiment. The power supply control circuit 22 of the embodiment executes such control that when the current, which is drawn to each of a predetermined number of portable devices, among a plurality of portable devices, is a first threshold (e.g. 1.5 A) or more, drawing the current of the first threshold or more to the portable devices other than the predetermined number of portable devices is prevented. In this power supply control circuit 22, compared to the power supply control circuit shown in FIG. 5, there are additionally provided a signal line between the first current limiter 26 and first bus switch 28, a signal line between the first bus switch 28 and second bus switch 29, and a signal line between the second bus switch 29 and second current limiter 27. By using signals which are exchanged through these signal lines, the power supply control circuit 22 limits the number of USB ports from which the current of the first threshold or more is drawn (i.e. the number of USB ports by which quick charging is executed). This number is set, for example, as specifications of the system of the computer 10. In the description below, for the purpose of simple description, it is assumed that the number of USB ports, to which the current of the first threshold or more is drawn, is one.

For example, in accordance with the status which has been set by the user, the EC 116 notifies the first bus switch 28 and second bus switch 29 of the status ID [2:0] that is a signal corresponding to the status. This notification is executed, for example, at a timing when the system has transitioned from S0 to Sx (Sx=S3, S4 or S5 of the power-saving state). When the system is in the power-saving state, the status is set to be one of the auto mode, DCP 1A mode and DCP 2A mode. In the meantime, this notification may be executed, responding to the change of the status by the user when the system is in S0.

Each of the first bus switch 28 and second bus switch 29 is a switch IC which switches the bus in accordance with notification from the EC 116. Specifically, in accordance with the status ID [2:0], the first bus switch 28 switches the path for passing a USB bus signal, which is output by the host controller 108, through to the first USB port 20, the unique value used in the first bus switch 28, and the path connected to the first USB port 20. Thereby, communication is controlled according to the status between the host controller 108 and the first USB device 20A that is attached to the first USB port 20. Similarly, in accordance with the status ID [2:0], the second bus switch 29 switches the path for passing a USB bus signal, which is output by the host controller 108, through to the second USB port 21, the unique value used in the second bus switch 29, and the path connected to the second USB port 21. Thereby, communication is controlled according to the status between the host controller 108 and the second USB device 21A that is attached to the second USB port 21.

In addition, power is supplied to the first USB port 20 with a current of up to the maximum current specified for the status (or a predetermined current specified for the status). When it is detected that the first USB device 20A is attached to the first USB port 20 and the detected first USB device 20A supports the set status, the charging of the first USB device 20A is started with power that is supplied to the first USB port 20 via the power supply circuit 24, etc. The first bus switch 28 notifies the first USB device 20A of the set status, for example, by using a sleep & charge signal (S&C signal). Using the S&C signal, the first USB device 20A determines whether the first USB device 20A supports the set status. If the first USB device 20A supports the set status, the first USB device 20A draws in the current which is supplied to the first USB port 20. Similarly, power is supplied to the second USB port 21 with a current of up to the maximum current specified for the status (or a determined current specified for the status). When it is detected that the second USB device 21A is attached to the second USB port 21 and the detected second USB device 21A supports the set status, the charging of the second USB device 21A is started with power that is supplied to the second USB port 21 via the power supply circuit 24, etc. The second bus switch 29 notifies the second USB device 21A of the set status, for example, by using an S&C signal. Using the S&C signal, the second USB device 21A determines whether the second USB device 21A supports the set status. If the second USB device 21A supports the set status, the second USB device 21A draws in the current which is supplied to the second USB port 21.

The first current limiter 26 is an IC that is inserted in the power supply line, through which power is supplied from the power supply circuit 24 to the first USB port 20, and that stops an output when the supplied current has exceeded a predetermined current. The power that is supplied from the power supply circuit 24 to the first USB port 20 has a predetermined voltage (e.g. 5 V). The first current limiter 26 starts the power supply to the first USB port 20, in response to an enable signal output from the EC 116. Then, the first current limiter 26 detects the current supplied to the first USB port 20 (i.e. the current drawn to the USB device 20A), and controls the power supply to the first USB port 20, based on the detected current.

When the current is smaller than the first threshold (e.g. 1.5 A), the first current limiter 26 continues the power supply to the first USB port 20. Specifically, the first current limiter 26 determines that normal charging is executed for the first USB device 20A which is attached to the first USB port 20, and the first current limiter 26 then continues the power supply.

When the current exceeds the second threshold (e.g. 2 A), the first current limiter 26 stops the power supply to the first USB port 20. That is, when the current exceeds the second threshold, the first current limiter 26 shuts off the current drawn to the first USB device 20A. To be more specific, when the current has exceeded the second threshold, the first current limiter 26 notifies the EC 116 that the current has exceeded the second threshold (over-current). Responding to the notification by the first current limiter 26, the EC 116 outputs the disable signal to the first current limiter 26. Then, responding to the disable signal output by the EC 116, the first current limiter 26 stops (interrupts) the power supply to the first USB port 20.

In addition, when the current is equal to or greater than the first threshold and is equal to or smaller than the second threshold, the first current limiter 26 determines that quick charging is being executed for the first USB device 20A, and then notifies the first bus switch 28 that quick charging is being executed for the first USB device 20A.

Responding to the notification from the first current limiter 26, the first bus switch 28 notifies the second bus switch 29 that quick charging is being executed for the first USB device 20A. Then, responding to the notification from the first bus switch 28, the second bus switch 29 executes such setting that quick charging (e.g. DCP 2A mode) for the second USB device 21A, which is attached to the second USB port 21, is prohibited. For example, the second bus switch 29 internally changes the status ID2 from “H” to “L”, thereby setting the status of the second bus switch 29 to be a status (second status) other than the DCP 2A mode (first status).

In accordance with the changed status, the second bus switch 29 switches the path for passing a USB bus signal, which is output by the host controller 108, through to the second USB port 21, the unique value used in the second bus switch 29, and the path connected to the second USB port 21. Thereby, since normal charging (i.e. power supply with current of less than the first threshold) is executed for the second USB device 21A, the number of USB ports, which are permitted to execute quick charging (i.e. power supply with current of the first threshold or more), can be limited to one.

The second current limiter 27 is an IC that is inserted in the power supply line, through which power is supplied from the power supply circuit 24 to the second USB port 21, and that stops an output when the supplied current has exceeded a predetermined current. The power supplied from the power supply circuit 24 to the second USB port 21 has a predetermined voltage (e.g. 5 V). The second current limiter 27 starts the power supply to the second USB port 21, in response to an enable signal output from the EC 116. Then, the second current limiter 27 detects the current supplied to the second USB port 21 (i.e. the current drawn to the USB device 21A), and then controls the power supply to the second USB portion 21, based on the detected current.

When the current is smaller than the first threshold, the second current limiter 27 continues the power supply to the second USB port 21. Specifically, the second current limiter 27 determines that normal charging is being executed for the second USB device 21A which is attached to the second USB port 21, and the second current limiter 27 then continues the power supply.

When the current exceeds the second threshold, the second current limiter 27 stops the power supply to the second USB port 21. That is, when the current exceeds the second threshold, the second current limiter 27 shuts off the current drawn to the second USB device 21A. To be more specific, when the current has exceeded the second threshold, the second current limiter 27 notifies the EC 116 that the current has exceeded the second threshold. Responding to the notification from the second current limiter 27, the EC 116 outputs the disable signal to the second current limiter 27. Then, responding to the disable signal output from the EC 116, the second current limiter 27 stops the power supply to the second USB port 21.

In addition, when the current is equal to or greater than the first threshold and is equal to or smaller than the second threshold, the second current limiter 27 determines that quick charging is being executed for the second USB device 21A, and then notifies the second bus switch 29 that quick charging is being executed for the second USB device 21A.

Responding to the notification from the second current limiter 27, the second bus switch 29 notifies the first bus switch 28 that quick charging is being executed for the second USB device 21A. Then, responding to the notification from the second bus switch 29, the first bus switch 28 executes such setting that quick charging (e.g. DCP 2A mode) for the first USB device 20A, which is attached to the first USB port 20, is prohibited. For example, the first bus switch 28 internally changes the status ID2 from “H” to “L”, thereby setting the status of the first bus switch 28 to be a status (second status) other than the DCP 2A mode (first status).

In accordance with the changed status, the first bus switch 28 switches the path for passing a USB bus signal, which is output by the host controller 108, through to the first USB port 20, the unique value used in the first bus switch 28, and the path connected to the first USB port 20. Thereby, since normal charging is executed for the first USB device 20A, the number of USB ports, which are permitted to execute quick charging (i.e. power supply with current of the first threshold or more), can be limited to one.

In the meantime, for example, when quick charging (DCP 2A mode) is being executed for the first USB device 20A and normal charging (DCP 1A mode) is being executed for the second USB device 21A by the above-described operation, the notification indicating that the quick charging is being executed for the first USB device 20A is stopped upon completion of the charging of the first USB device 20A or upon detachment of the first USB device 20A from the first USB port 20. Specifically, the notification indicating that the first USB device 20A is being quickly charged, which is sent from the first current limiter 26 to the second bus switch 29 via the first bus switch 28, is stopped. Responding to the stop of the notification, the second bus switch 29 sets the quick charging (e.g. DCP 2A mode) at the second USB port 21 to be permitted. For example, the second bus switch 29 internally changes the status ID2 from “L” to “H”, thereby restoring the status of the second bus switch 29 to the DCP 2A mode (status of quick charging). Then, when the second USB device 21A is attached to the second USB port 21, the quick charging for the second USB device 21A is started as described above.

By the above-described structure, quick charging can stably be executed when plural USB devices 20A and 21A are attached. When power is supplied to the external USB devices 20A and 21A which are attached to the USB ports 20 and 21, the number of ports, which can execute quick charging (i.e. charging with current of the first threshold or more), is limited so that the total currents for power supply, which are required by the USB devices 20A and 21A, may not exceed the power capacity that can be supplied by the computer 10. The control for limiting the number of ports is executed by the above-described power supply control circuit 22, and can be realized not by the OS 103A but by hardware. Specifically, there are provided a signal line between the first current limiter 26 and first bus switch 28, a signal line between the first bus switch 28 and second bus switch 29, and a signal line between the second bus switch 29 and second current limiter 27. Thereby, these modules (ICs) are interconnected by hardware, and thus the status of each USB port 20, 21 can be shared. By the realization on hardware, the power supply to the USB devices 20A and 21A can be controlled regardless of the system state (S0, S3, S4, S5). In addition, by the realization on hardware, the power supply to the USB devices 20A and 21A can be controlled without hindering the user from operating the computer 10 (i.e. without the user being conscious). In the meantime, the above-described first threshold and second threshold can arbitrarily be set by a hardware designer at a time of designing. Besides, the number of USB ports, which can execute quick charging at the same time, may not be limited to one, and may be set based on the power capacity that can be supplied by the computer 10.

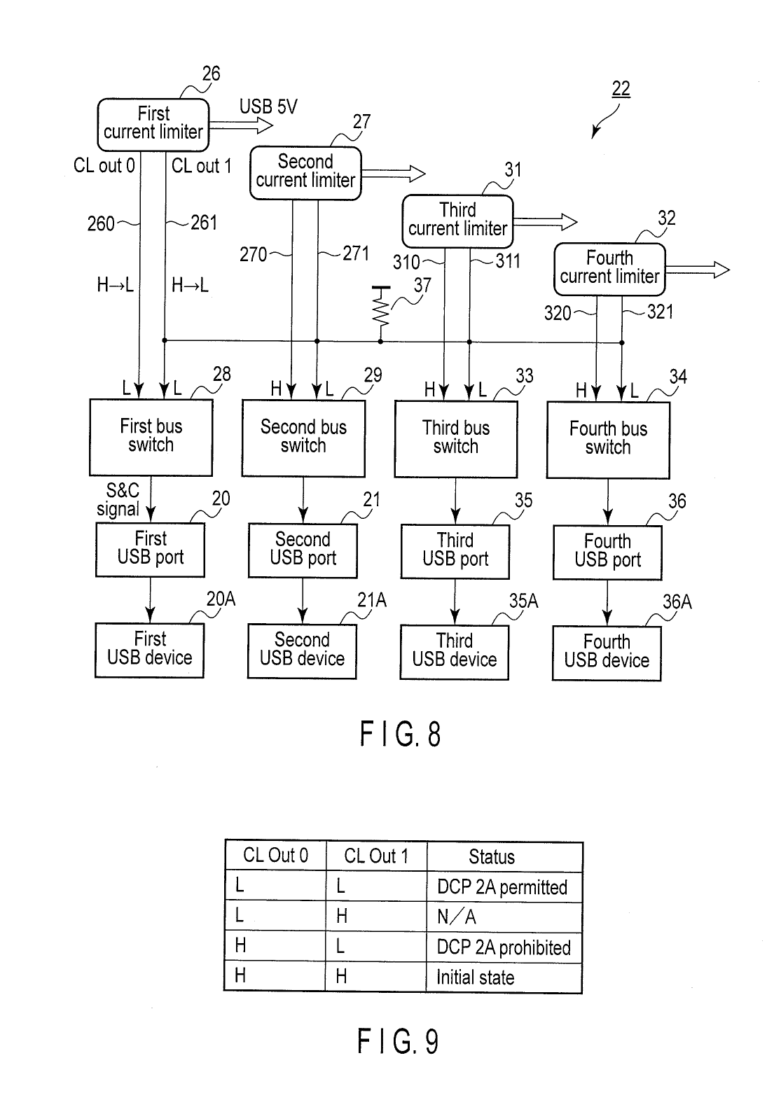

Next, referring to FIG. 8, another example of the power supply control circuit 22 is described. In the power supply control circuit 22 shown in FIG. 8, the number of USB ports, which are provided on the computer 10, is increased to four. While quick charging is executed at any one of four USB ports 20, 21, 35 and 36, quick charging (DCP 2A mode) at all the other ports is prohibited. Although FIG. 8 omits depiction of connections between the power supply circuit 24 and current limiters 26, 27, 31 and 32 and connections between the current limiters 26, 27, 31 and 32 and the USB ports 20, 21, 35 and 36, these are connected in the same fashion as illustrated in FIG. 7.

In the example shown in FIG. 8, the first current limiter 26 and first bus switch 28 are connected by two signal lines 260 and 261, the second current limiter 27 and second bus switch 29 are connected by two signal lines 270 and 271, the third current limiter 31 and third bus switch 33 are connected by two signal lines 310 and 311, and the fourth current limiter 32 and fourth bus switch 34 are connected by two signal lines 320 and 321. One of each pair of these two signal lines is commonly connected and pulled up by a resistor 37, and thereby wired-OR connected. A signal CL out 0 and a signal CL out 1 (hereinafter also referred to as CL out [1:0]), which are output from the current limiter 26, 27, 31, 32, is stipulated as shown in FIG. 9. Since the wired-OR connection is adopted in this example, the active state (quick charging state) is stipulated as “Low” output (i.e. a logical OR of a negative-true logic is calculated).

FIG. 9 illustrates an example of the relationship between signals CL out 0 and CL out 1, which are output from the current limiter 26, 27, 31, 32 to the bus switch 28, 29, 33, 34, and the status.

A signal CL out [1:0]=[L, L] is indicative of a status which permits DCP 2A mode. A signal CL out [1:0]=[L, H] is indicative of a status which prohibits DCP 2A mode. A signal CL out [1:0]=[H, H] is indicative of a status of an initial state (charging wait state or normal charging state). None of statuses is assigned to a signal CL out [1:0]=[H, L]. In addition, quick charging is prohibited when CL out [1:0]=[L, H], and quick charging is permitted in other cases.

In the power supply control circuit 22 shown in FIG. 8, when quick charging is being executed for the first USB device 20A (i.e. when the current is the first threshold or more and is the second threshold or less), the first current limiter 26 changes the signal CL out [1:0]=[H, H], which is indicative of the initial state, to the signal CL out [1:0]=[L, L] which is indicative of the permission of DCP 2A mode, and then outputs this signal. Since the first bus switch 28 does not change the status (charging mode) in accordance with the signal that is output from the first current limiter 26, the quick charging for the first USB device 20A is continued.

Since the signal line 261 corresponding to the CL out 1 are wired-OR connected with the signal lines 271, 311 and 321, as described above, the signal CL out 1=L is output to not only the first switch 28, but also to the second bus switch 29, third bus switch 33 and fourth bus switch 34. Accordingly, the CL out 0=H of the CL out [1:0]=[H, H], which is indicative of the initial state, and the CL out 1=L are output to the second bus switch 29, third bus switch 33 and fourth bus switch 34, and thereby the CL out [1:0]=[L, H], which is indicative of the prohibition of DCP 2A mode, is output. Responding to the received CL out [1:0]=[L, H], the second bus switch 29, third bus switch 33 and fourth bus switch 34 set the quick charging (DCP 2A mode) for the second USB device 21A, third USB device 35A and fourth USB device 36A to be prohibited. For example, the second bus switch 29, third bus switch 33 and fourth bus switch 34 internally change the status ID2, which is output by the EC 116, from “H” to “L”, thereby setting the status to be a status (status of normal charging) other than the DCP 2A mode.

By the above-described structure, while quick charging is being executed at any one of the four USB ports 20, 21, 35 and 36, quick charging (DCP 2A mode) can be prohibited at all the other ports.

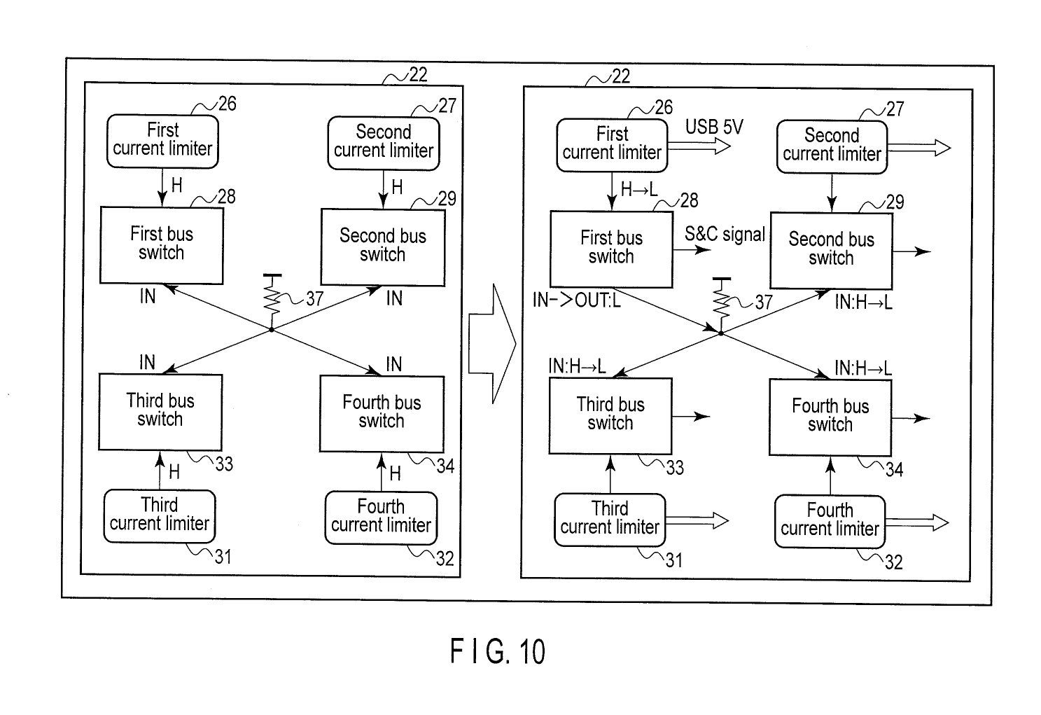

Referring to FIG. 10, still another example of the power supply control circuit 22 is described. In the power supply control circuit 22 shown in FIG. 10, like the example of FIG. 8, the number of USB ports, which are provided on the computer 10, is increased to four. While quick charging is being executed at any one of four USB ports 20, 21, 35 and 36, quick charging (DCP 2A mode) at all the other ports is prohibited. Although FIG. 10 omits depiction of the USB ports 20, 21, 35 and 36 and USB devices 20A, 21A, 35A and 36A, these are connected (attached) in the same fashion as illustrated in FIG. 8.

In the example shown in FIG. 10, the first bus switch 28, second bus switch 29, third bus switch 33 and fourth bus switch 34 are interconnected by signal lines. These signal lines are pulled up by a resistor 37 and are connected such that when a signal has been output from any one of the first bus switch 28, second bus switch 29, third bus switch 33 and fourth bus switch 34, this signal is received by all the other bus switches. In short, an output from one bus switch is notified to all the other bus switches.

The current limiter 26, 27, 31, 32 outputs a signal “L” (Low) to the bus switch 28, 29, 33, 34 when quick charging is being executed for the associated USB device 20A, 21A, 35A, 36A (i.e. when the current is the first threshold or more and is the second threshold or less), and outputs a signal “H” (High) to the bus switch 28, 29, 33, 34 in other cases.

The bus switch 28, 29, 33, 34 sets a signal pin for connection between the bus switches 28, 29, 33 and 34 at an input (IN) while the signal “H” is being output from the associated current limiter 26, 27, 31, 32. Responding to the output of the signal “L” from the current limiter 26, 27, 31, 32, the bus switch 28, 29, 33, 34 switches the signal pin to an output (OUT).

For example, when the first bus switch 28 has received the signal “L” that is output from the first current limiter 26, the first bus switch 28 switches the signal pin to the output (OUT). Then, the first bus switch 28 outputs this signal “L” to the other bus switches 29, 33 and 34.

Upon receiving the signal “L” which has been output from the first bus switch 28, the other bus switches 29, 33 and 34 set quick charging (DCP 2A mode) to be prohibited.

By the above-described structure, while quick charging is being executed at any one of the four USB ports 20, 21, 35 and 36, quick charging (DCP 2A mode) can be prohibited at all the other ports. In the meantime, in the example of FIG. 10, the number of signal lines for connection between the modules (ICs) can be made smaller than in the example of FIG. 8. Therefore, the cost of the power supply control circuit 22 can be reduced.

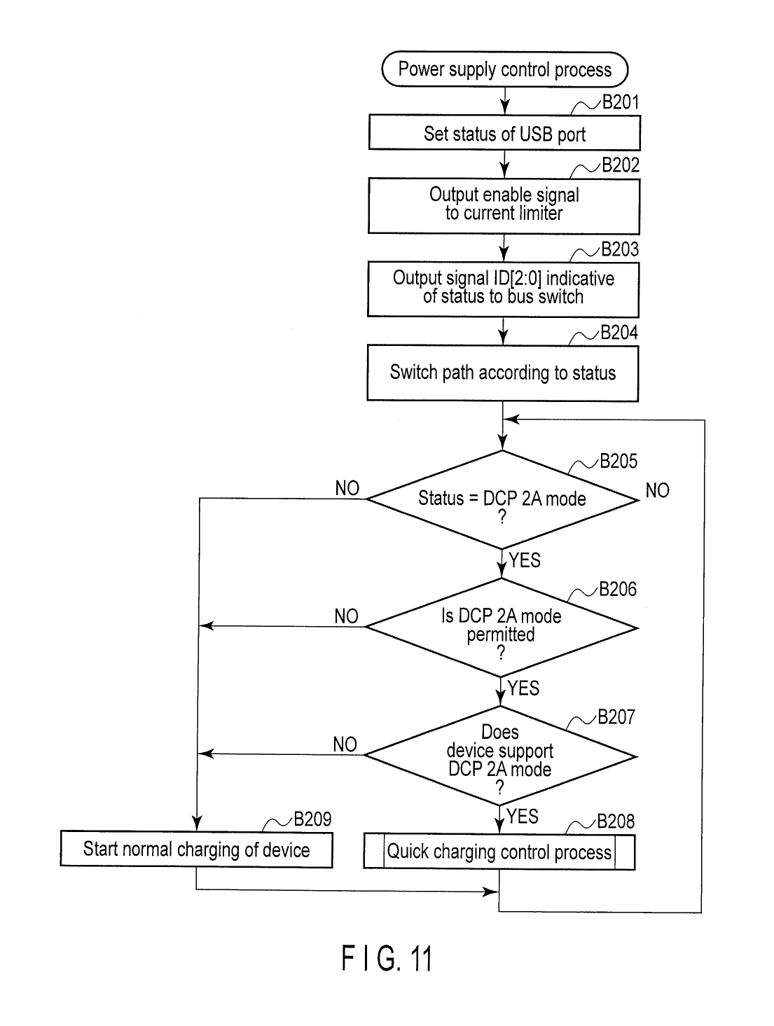

Next, referring to a flowchart of FIG. 11, a description is given of an example of the procedure of a power supply control process which is executed by the power supply control circuit 22. In the description below, it is assumed that power supply is controlled in the order of the first USB port 20 and second USB port 21.

To start with, the EC 116 sets the status of the USB port 20, 21 (block B201). For example, the EC 116 sets the status of the USB port 20, 21 in accordance with the setting by the user. Next, the EC 116 outputs an enable signal to the current limiter 26, 27 (block B202). The current limiter 26, 27 starts power supply to the USB port 20, 21, responding to the enable signal which has been output from the EC 116. In addition, the EC 116 outputs the signal ID [2:0] indicative of the set status to the bus switch 28, 29 (block B203). In accordance with the signal ID [2:0] indicative of the status, the bus switch 28, 29 switches the path for passing a USB bus signal through to the USB port 20, 21, and the path that connects the bus switch 28, 29 and the USB port 20, 21 (block B204).

Next, based on the signal ID [2:0], the first bus switch 28 determines whether the status is the DCP 2A mode or not (block B205). When the status of the first USB port 20 is not the DCP 2A mode (NO in block B205), normal charging of the first USB device 20A is started (block B209).

When the status is the DCP 2A mode (YES in block B205), the first bus switch 28 determines, based on the notification by the first current limiter 26, whether the DCP 2A mode is permitted or not (block B206). For example, when there is no notification from the first current limiter 26, the first bus switch 28 determines that all statuses including the DCP 2A mode are permitted.

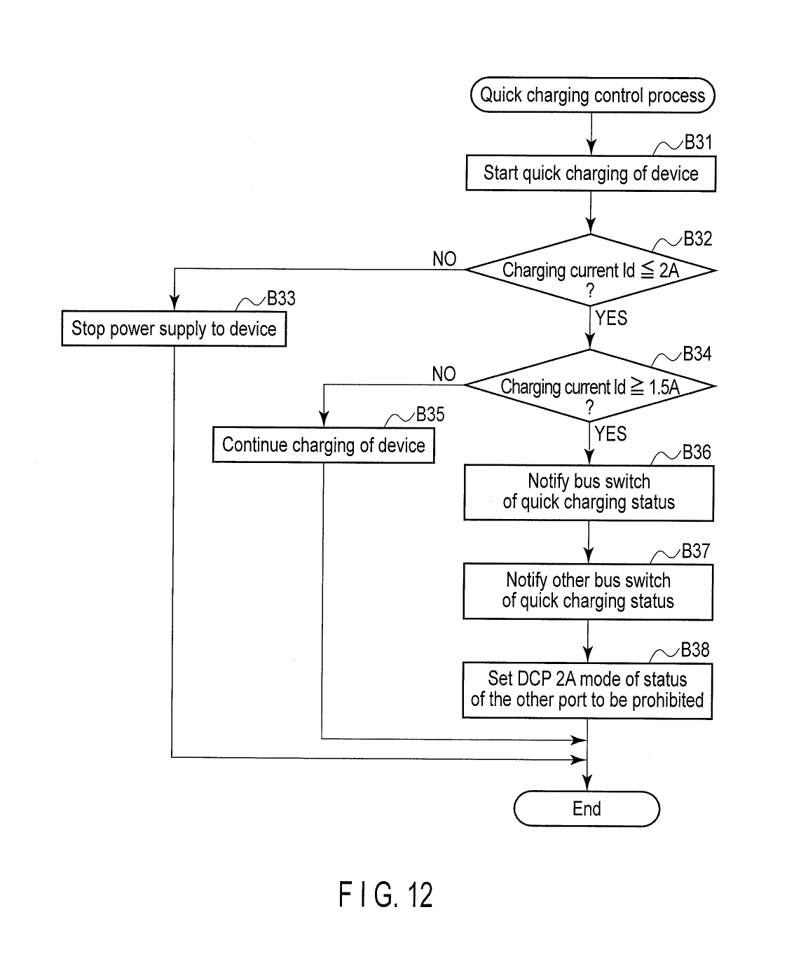

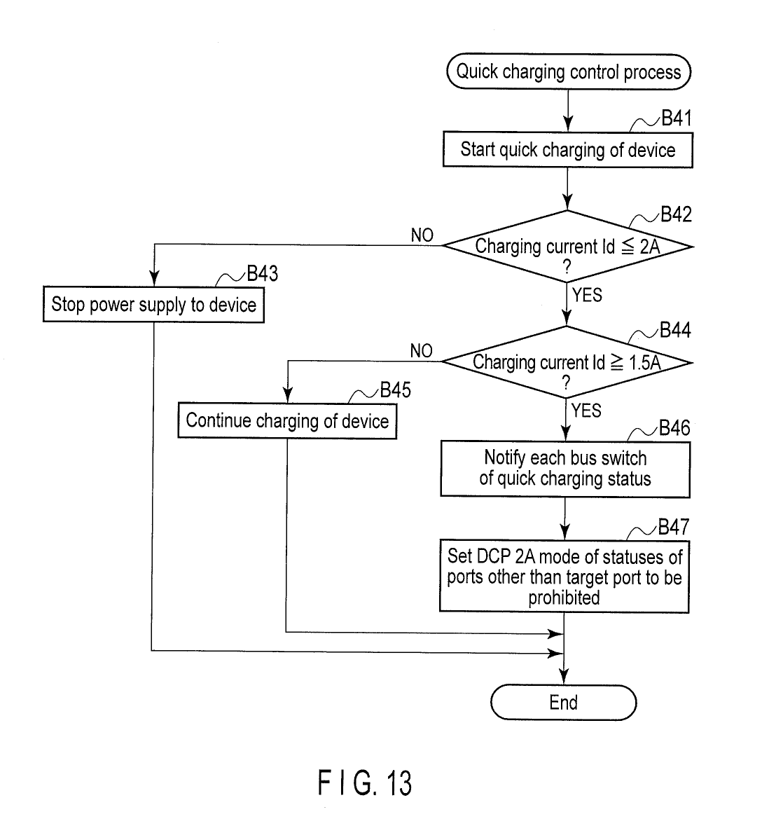

When the DCP 2A mode is permitted for the first USB port 20 (YES in block B206), the first USB device 20A determines whether the device 20A supports the DCP 2A mode (block B207). When the first USB device 20A supports the DCP 2A mode (YES in block B207), a quick charging control process for the first USB device 20A is executed (block B208). In this quick charging control process, the respective components in the power supply control circuit 22 operate in such a manner that quick charging is executed for only a predetermined number (e.g. one) of the USB devices which are attached to the USB ports provided on the computer 10. An example of the procedure of the quick charging control process will be described later with reference to FIGS. 12 and 13.

When the DCP 2A mode is not permitted for the first USB port 20 (NO in block B206) or when the first USB device 20A does not support the DCP 2A mode (NO in block B207), normal charging of the first USB device 20A is started (block B209).

When there is another port in the computer 10, the same process as the process of block B205 to block B209 is executed for this port (the second USB port 21 in this example).

A flowchart of FIG. 12 illustrates an example of the procedure of a quick charging control process which corresponds to block B208 in FIG. 11. In the description below, it is assumed that the power supply control circuit 22 has the structure shown in FIG. 7 and that a device which is first attached to the USB port is the first USB device 20A. However, the same process is executed for other portable devices including the second USB device 21A in the order in which such portable devices are attached (i.e. in the order of detection of attachment). In addition, it is assumed that the voltage of power, which is supplied to the USB device 20A, 21A, is fixed (e.g. 5 V).

To start with, the first USB device 20A starts quick charging with use of power which is supplied by the computer 10 via the USB port 20 (block B31). Then, the first current limiter 26 determines whether a current (charging current) Id of power, which is being supplied to the first USB device 20A, is equal to or smaller than 2 A (second threshold) (block B32). When the charging current Id greater than 2 A (NO in block B32), the first current limiter 26 stops the power supply to the first USB device 20A (block B33).

When the charging current Id is equal to or smaller than 2 A (YES in block B32), the first current limiter 26 determines whether the charging current Id is equal to or greater than 1.5 A (first threshold) (block B34). When the charging current Id is smaller than 1.5 A (NO in block B34), the charging of the first USB device 20A is continued (block B35).

When the charging current Id is equal to or greater than 1.5 A (YES in block B34), the first current limiter 26 notifies the first bus switch 28 of the quick charging status which indicates that the first USB device 20A is being quickly charged (block B36). Responding to the notification from the first current limiter 26, the first bus switch 28 notifies the other bus switch (second bus switch 29) that the first USB device 20A is in the quick charging status (block B37). Responding to the notification by the first bus switch 28, the other switch (second bus switch 29) does not permit the DCP 2A mode (first status) to be set as the status of the other port (second USB port 21) (block B38). Thereby, when the first USB device 20A is being quickly charged, quick charging is not executed in the other device (second USB device 21A). In short, the number of ports, which can execute quick charging, is limited to the predetermined number.

A flowchart of FIG. 13 illustrates another example of the procedure of the quick charging control process which corresponds to block B208 in FIG. 11. In the description below, it is assumed that the power supply control circuit 22 has the structure shown in FIG. 8 and that a device which is first attached to the USB port is the first USB device 20A. However, the same process is executed for other portable devices such as the second USB device 21A, third USB device 35A and fourth USB device 36A in the order in which such portable devices are attached (i.e. in the order of detection of attachment). In addition, it is assumed that the voltage of power, which is supplied to the USB device 20A, 21A, 35A, 36A, is fixed (e.g. 5 V).

To start with, the first USB device 20A starts quick charging with use of power which is supplied by the computer 10 via the USB port 20 (block B41). Then, the first current limiter 26 determines whether a current (charging current) Id of power, which is being supplied to the first USB device 20A, is equal to or smaller than 2 A (second threshold) (block B42). When the charging current Id is greater than 2 A (NO in block B42), the first current limiter 26 stops the power supply to the first USB device 20A (block B43).

When the charging current Id is equal to or smaller than 2 A (YES in block B42), the first current limiter 26 determines whether the charging current Id is 1.5 A (first threshold) (block B44). When the charging current Id is smaller than 1.5 A (NO in block B44), the charging of the first USB device 20A is continued (block B45).

When the charging current Id is equal to or greater than 1.5 A (YES in block B44), the first current limiter 26 notifies each bus switch 28, 29, 33, 34 of the quick charging status which indicates that the first USB device 20A is being quickly charged (block B46). Responding to the notification from the first current limiter 26, the second bus switch 29, third bus switch 33 and fourth bus switch 34 do not permit the DCP 2A mode (first status) to be set as the associated status (block B47). Thereby, when the first USB device 20A is being quickly charged, quick charging is not executed in the other devices (second USB device 21A, third USB device 35A and fourth USB device 36A). In short, the number of ports, which can execute quick charging, is limited to the predetermined number.

As has been described above, according to the present embodiment, quick charging can stably be executed when plural portable devices are attached. In this embodiment, when power is supplied to plural USB devices which are attached to plural USB ports, the number of ports, which can execute quick charging (i.e. charging with current of the first threshold or more), is limited so that the total power supply currents, which are required by the plural USB devices, may not exceed the power capacity that can be supplied by the computer 10. The current limiter 26, 27 detects the current drawn to the plural USB devices. When the number of USB devices, into which the current of the first threshold or more is drawn, has reached a predetermined number, the statuses are dynamically controlled so that the current of the first threshold or more may not be drawn to the USB device which is subsequently connected.

In order to adapt to quick charging of a portable device, it is thinkable to change the allowable value of the power supply (system power supply) of the computer 10 or to change the rated power supply of the AC adapter 30. However, this may possibly lead to an increase in cost or degradation in usability. In the present embodiment, the portable device can stably be quickly charged, without making such changes.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus capable of charging batteries of a plurality of portable devices, the apparatus comprising:
a plurality of ports configured to be attached to the plurality of portable devices;
a current detector configured to detect a current drawn by each of the plurality of portable devices when the plurality of portable devices are attached to the plurality of ports; and
a power supply controller configured to prevent a current of a first threshold or more from being supplied to an additional portable device when a number of portable devices, each having the current drawn equal to or greater than the first threshold, reaches a first number.

2. The information processing apparatus of claim 1, further comprising a status setting module configured to set each of the plurality of ports in either a first status or a second status, wherein in the first status, a maximum current drawn to a portable device is equal to or greater than the first threshold, and in the second status, the maximum current is smaller than the first threshold,
wherein the power supply controller is configured to set a first port of the plurality of ports in the second status when the current drawn to each of the first number of portable devices is equal to or greater than the first threshold, wherein the additional portable device is attached to the first port.

3. The information processing apparatus of claim 1, wherein the power supply controller is configured to interrupt a current drawn to a first portable device of the plurality of portable devices when the current drawn to the first portable device is greater than a second threshold, and to prevent the current of the first threshold or more from being drawn to the additional portable device when the current drawn to each of the first number of portable devices is equal to or greater than the first threshold and is equal to or smaller than the second threshold.

4. The information processing apparatus of claim 1, wherein the first number is determined based on power which the information processing apparatus is capable of supplying to the plurality of portable devices.

5. The information processing apparatus of claim 1, wherein the plurality of ports comprise a port configured to support Universal Serial Bus standards.

6. A control method of controlling an operation of an information processing apparatus capable of charging batteries of a plurality of portable devices, the method comprising:
detecting a current drawn to each of the plurality of portable devices when the plurality of portable devices are attached to a plurality of ports provided in the information processing apparatus; and
preventing a current of a first threshold or more from being supplied to an additional portable device when a number of portable devices, each having the current drawn equal to or greater than the first threshold, reaches a first number.

7. The control method of claim 6, further comprising setting each of the plurality of ports in either a first status or a second status, wherein in the first status, a maximum current drawn to a portable device is equal to or greater than the first threshold, and in the second status, the maximum current is smaller than the first threshold,
wherein the preventing comprises setting a first port of the plurality of ports in the second status when the current drawn to each of the first number of portable devices is equal to or greater than the first threshold, wherein the additional portable device is attached to the first port.
